(19) United States
(12) Patent Application Publication
(10) Pub. No.: US 2008/0264882 A1
(43) Pub. Date: Oct. 30, 2008

(54) Urn Made of Glass Material

(76) Inventor: Annette Sviberg-Krahner, Orrefors (SE)

Correspondence Address: DICKSTEIN SHAPIRO LLP, 1825 EYE STREET NW, Washington, DC, 20006-5403, US

(21) Appl. No.: 12/089,685

(22) PCT Filed: Oct. 3, 2006
(86) PCT No.: PCT/SE2006/001121

§ 371 Date: Apr. 9, 2008

(30) Foreign Application Priority Data
Oct. 10, 2005 (SE) 0502215-7

(51) Int. Cl. A61G 17/08

(52) U.S. Cl. 211/85.27

(57) ABSTRACT

The invention relates to an urn made of a mixture (2) of different selected materials, said urn (1) is destructible and can be decomposed during a certain restricted time after an interment in earth. Said urn (1) is mainly made of glass containing a mixture of at least the following materials in the composition (2), such as sand, sodium, and preferably also lime, dolomite and feldspar for creating a silicon network, constituting the ready urn (1), ash (8) being left after a cremated dead person and its chest containing carbonate and phosphate, is enclosed in a space (4) in said urn (1) during the interment and that a liquid (9), which is added to said space (4), constitutes a basic solution (14) together with said ash (8), which destructs the silicon network at the same time as the urn (1) as time goes on is destructed and decomposed.

The present invention refers to an urn made of glass material consisting of a mixture of different materials, at least the following materials existing in said mixture, such as sand, sodium, and preferable also lime, feldspar and dolomite for constituting a silicon network, which are building up the ready urn. Ash after a cremated dead person lying in a coffin contains carbonate and phosphate, which are enclosed in a space in the urn when the same is buried in the earth, whereupon water, added to said space together with the ash, constitutes a basic solution, which breaks down said silicone network in the urn, which then as time goes on decomposes.

Concerning structures of this type existing on the market there are today different urns made of materials, which can be broken down and which make that the urn as the time goes destroys after being buried in the earth. According to previously known technique there is in SE 523064 described an urn made of gelatine, which as the time goes is broken down when buried in the same way as according to DE 19744331, in which the urn is made of a decomposable plastic. According to SE 500860 the urn is made of bark and flour in order to moulder away in the earth. According to WO 9321888 the urn is made of wood in order to moulder. According to DE 202004005989 the urn is made of sand stone, so that it can be broken down in earth. The urns mentioned above are difficult to vary in their look, as the manufacturing technique in a high degree determines the designing. A good design is a strong sentimental creating factor, which helps to give a serious and ceremonious atmosphere during an interment. Today there are only a few urns made of glass. However, these are not destructive but remain in the earth a too long time after the interment. This is a great problem today, since one wants that the urns shall disappear during a short period of time in order to give room for new interments, and that's why regulations exist in that destructive urns shall be used, which can be broken down during a period of time less than 15 years. Today it is known to make bottles of glass having an alkali rich, basic mixture of materials consisting of only a greater amount of sodium (NaCo3) and sand (SiO2), to built up a silicon network, which can be broken down by sunlight and water in e.g. damp grass during a time of about 3 months in a sour environment, which is breaking down the silicon network. Such a mixture of materials cannot be used for an urn of glass, since it is not situated in sunlight.

One object of the present invention is to eliminate those drawbacks existing in the structures mentioned above in that the ash after a dead person and her chest together with an amount liquid added to the urn, creates a basic solution, which breaks down the silicon network in the glass material, which as times goes on decomposes. The characterizing features of the invention are stated in the claims enclosed.

Thanks to the invention an urn has been provided made of glass comprising mixture of different, selected materials, which can be broken down and decompose during a certain time after an interment in earth. The most important advantages of the invention are thus the creation of an attractive and demanded urn of glass, which carries out the aesthetic, ethical and serious demands required for an interment and that the product still can be broken down within at least 15 years after the interment. The glass as material is to be preferred, since it can easily be manufactured and formed and coloured in nearly any variations, which is a great advantage.

The invention is closer described below referring to two embodiment examples, in which

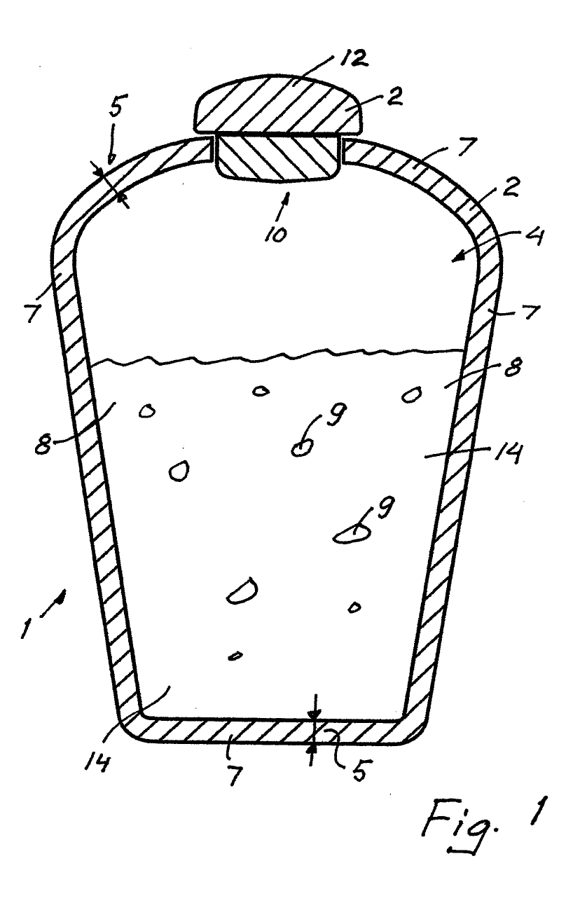

FIG. 1 shows a vertical section through an urn before an interment and

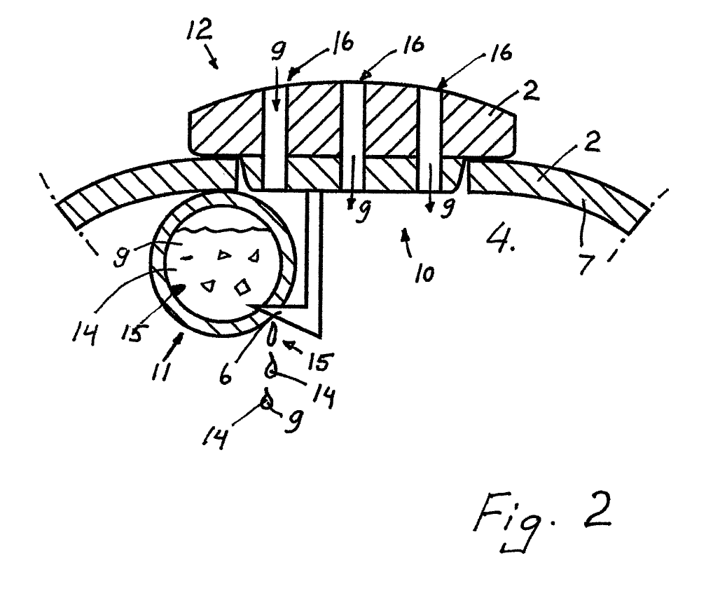

FIG. 2 shows a vertical section through a part of an urn at its cover.

As can be seen from FIG. 1 here is illustrated an urn 1 made of a mixture 2 of different, selected materials, which are building up the ready urn 1, whereby ash 8 can be enclosed in a space 4 in said urn 1. Liquid 9 can be added to the space 4 for constituting a basic solution 14 together with said ash 8. The space 4 is surrounded by walls 7 having a certain preselected, desired thickness 5. The urn 1 has an opening 10 provided with a cover 12, which can consist of a material soluble by water such as e.g. board.

As can be seen from FIG. 2 the liquid 9, crystal sodium or the extra added basic material 15 can be enclosed in a receptacle 11, and the same is released by mechanical influence of said receptacle 11 in letting a point means 6, provided near the cover 12, make an opening in the receptacle 11, so that the contents is released to mix with the ash 8. Liquid 9 in the form of water can also leak in through openings 16 situated in the cover 12 and thereafter pass through the opening 10, so that the water is mixed with the ash 8.

The urn 1, which is made of glass consisting of a mixture of different, selected materials, is broken down and decomposed during a certain time after the interment in the earth. The glass material consists of a mixture containing at least the following materials, such as sand in the form of silicon (SiO2), sodium (Na2CO3), but preferable also lime (CaCO3), feldspar (K/NaSi3O8) and dolomite (Ca/MgCO3) and also phosphates in a certain amount for constituting of a silicon network, which creates the ready urn 1. According to the invention this mixture is melted during a high temperature 1000-2000° C. in an oven to a glass mass for further treatment in the form of casting in a mould, blow moulding, rolling, grinding or other mechanical treatment by tools. The ash after a dead person together with a chest contains carbonates and phosphates, which, when the urn 1 is buried, is enclosed in the space 4 of the urn 1. A liquid 9, preferably water in an amount of about two up to ten decilitres or an amount or soda crystal (Na2CO3.10H2O) is added the space 4 for constituting the basic solution 14 together with the ash 8, which forms a pulpy mass, which attacks the silicon network, which as time goes on, is broken down and decomposed and is joining more and more with the surrounded earth after the interment. The mixture has at a preferable embodiment example and in order to receive a faster destruction of the silicone network than for a common glass material, i.e. a mixture with a high destruction index, a so called P-value, which lies over 300 having the following mixture: Silicon (SiO2) 40-80%, Sodium (Na2CO3) 10-30%, lime (CaCO3) 0-20%, felspar (Na, Ka)AlSiSi3O8) 0-5%, Dolomite (Mg/CaCO3) 1-10% and an amount of phosphates of between 0-10%. Common glass has a P-value, which not often is above 10.

The space 4 containing the ash 8 is surrounded by walls 7 and bottom and a cover 12. Thinner walls 7 in said urn make that the silicon network will decompose quicker than thicker walls, so that the time it takes for the destruction can be shorter or longer depending on the variation of the wall thickness. According to the preferred embodiment example of said urn the cover 12 can be opened for filling of the ash 8 and thereafter it is closed. According to the invention the liquid in the form of water or soda crystal can at this time be filled up and enclosed in the receptacle 11 arranged in or in connection to said space 4. Then, the liquid can be released from the receptacle 11 in connection with that the cover 12 is put onto the urn 1 using an added force, so that the point means 6 makes a hole in the receptacle 11 so that its contents can flow out and be mixed with the ash 8, whereupon the urn 1 slowly is destructed and decomposed.

1. An urn made of a mixture (2) of different selected materials, said urn (1) is destructible and can be decomposed during a certain restricted time after an interment in earth, characterized in that said urn (1) is mainly made of glass containing a mixture of at least the following materials in the composition (2), such as sand, sodium, and preferably also lime, dolomite and felspar for creating a silicon network, constituting the ready urn (1), ash (8) being left after a cremated dead person and its chest containing carbonate and phosphate, is enclosed in a space (4) in said urn (1) during the interment and that a liquid (9), which is added said space (4) constitutes a basic solution (14) together with said ash (8), which destructs the silicon network at the same time as the urn (1) as time goes on is destructed and decomposed.

2. An urn according to claim 1, characterized in that said liquid consists of water and/or soda crystal (Na₂CO₃.10H₂O} and/or another extra added basic material (15).

3. An urn according to claim 1, characterized in that the glass material has a destruction index a so called P-value, which is over 300, whereby the silicone network is destructed faster, in about 15 years or less, than the common glass material, which has P-values below 10, said composition (2) having the following percentage distribution in weight percent: silicone (SiO₂) 40-80%, sodium (Na₂CO₃) 10-30%, lime (CaO₃) 0-20%, felspar ((Na, K) AlSi₃O₈ ) 0-5%, dolomite (CaMg(CO₃)) 0-10% and phosphates 0-10%, so that desired P-values can be achieved from a composition (2), where the P-value of the glass material can be calculated from its chemical mixture according to the following connection per 100 parts SiO₂: ln P=−2.77365+0.191×(Na₂O)-0.0464×(CaO)-0.0982×(Al₂O₃)-0.07864×(MgO).

4. An urn according to claim 1, characterized in that the space (4) containing the ash (8) is surrounded by at least one wall (7) having a certain predetermined thickness (5), so that a thinner wall makes the silicone network to decompose faster than a thicker wall (7).

5. An urn according to claim 1, characterized in that the urn (1) has at least one opening (10) for filling of ash (8) and/or the liquid (9).

6. An urn according to claim 1, characterized in that the basic solution (14) contains water and/or soda crystal corresponding to a liquid volume of about 2 dl-10 dl, so that the basic solution (14) constitutes a pulpy mass together with the ash (8).

7. An urn according to claim 1, characterized in that the opening (10) has at least one cover (12), which can be opened and closed.

8. An urn according to claim 1, characterized in that the cover (12) is made of a material, which is dissoluble in water, such as e.g. board or has at least one opening (16), so that water from the moisture in earth can leak into said space (4) after the interment at the same time as the basic solution (14) is created together with the ash (8) and the water which has leaked into the same from the moisture in earth.

9. An urn according to claim 1, characterized in that the liquid (9) is the contents in at least one receptacle (11), which is provided in and/or in connection to the space (4), at least one portion of the content being releasable by some form of mechanical or chemical influence of the receptacle (11) in connection with that the cover (12) is placed on the urn (1), when the force to put on the cover (12) also is used to let e.g. at least one point means (6) provided next to the cover (12) perform at least one opening in the receptacle (11) at the same time as at least one portion of the contents is released and mixed with the ash (8).

10. A method for manufacturing an urn (1) according to claim 1, characterized in that the composition (2) is melted under a high temperature 1000-2000° C. in a glass oven to a glass mass for further treatment in the form of casting in a mold, blow molding, rolling, grinding or another mechanical treatment using tools.
